(19) United States
(12) Patent Application Publication
(10) Pub. No.: US 2011/0064848 A1
(43) Pub. Date: Mar. 17, 2011

(54) USE OF ELECTRICITY TO INCREASE THE TRANSFER OF MOLECULES ACROSS BIOLOGICAL MEMBRANES FOR THE ACCELERATION OF DAIRY FERMENTATION

(76) Inventors: Aaron P. Wlaschin, St. Paul, MN (US); Glen Cole, Minnetonka, MN (US); Christopher A. Gordon, Victoria, MN (US); Maeve C. Murphy, Plymouth, MN (US)

(21) Appl. No.: 12/879,040

(22) Filed: Sep. 10, 2010

Related U.S. Application Data
(60) Provisional application No. 61/241,539, filed on Sep. 11, 2009.

(51) Int. Cl. A23C 9/123

(52) U.S. Cl. 426/43

(57) ABSTRACT

A process for preparing a dairy fermentation product comprises inoculating lactic acid bacteria into a dairy base composition and initiating fermentation. Electrodes are placed in direct contact to the inoculated dairy base composition, and electric pulses are created, whereby pores are formed in the lactic acid bacteria so that molecules in the dairy base composition gain entry into the lactic acid bacteria.

### CROSS-REFERENCE TO RELATED APPLICATION

This application claims the benefit of priority under 35 U.S.C. 119(e)(1) of a provisional patent application Ser. No. 61/241,539, filed Sep. 11, 2009, which is incorporated herein by reference in its entity.

### FIELD OF THE INVENTION

The invention relates to a method for preparing food products. More particularly, the invention relates to methods for preparing fermented dairy products utilizing the electrification of a dairy base. The invention is particularly useful in the preparation of yogurt products.

### BACKGROUND OF THE INVENTION

Fermented dairy products, such as yogurt, typically refer to compositions produced by culturing (fermenting) one or more dairy ingredients, also sometimes referred to as a dairy base, with a bacterial culture that contains the lactic acid-producing bacteria, such as Lactobacillus bulgaricus and/or Streptococcus thermophilus. Such products are available in a wide variety of styles and formulations.

Yogurt consumers are developing particularly refined tastes for fermented dairy products. This has led to significant diversification of fermented dairy product offerings. One of the key factors in generating different tastes and textures is utilization of specialized unique blends of dairy fermentation strains. This creates a stress on the manufacturing facilities, affecting plant efficiencies.

Beyond the aspect of introducing a new set of dairy fermentation strains for the manufacturing plants to manage, there is another need to accelerate the fermentation of yogurt. In some fermented dairy products, the final attributes of these new products are often dependent on the unique bouquet of flavors generated from strains that have naturally lengthy fermentation times. To make the process commercially viable, it is highly desirable to accelerate the fermentation.

Prior art in the field of accelerating dairy fermentation focuses on the addition of fermentation enhancers to the dairy base, supplementing nutrients or extracts that are at metabolically limiting concentrations. The present invention addresses the problem via another route, in bypassing cellular transport mechanisms and providing a direct route for these nutrients to enter the cellular metabolism.

### SUMMARY OF THE INVENTION

The present invention describes the application of a direct electrical field to a dairy fermentation. In this process, dairy fermentation strains are inoculated into a dairy base. Electrodes are provided in direct contact to the inoculated dairy base. An external power supply connected to the electrodes is used to create an electric pulse through the inoculated dairy base. The applied electric field affects the electric charges on the internal and external sides of the cellular membrane of the dairy fermentation strains. It has been discovered that the process does not work if the electrodes are insulated or isolated from the dairy base. At least one electric pulse is applied to the inoculated dairy base using the electrodes at an electric field strength sufficiently high to form pores in the lactic acid bacteria to allow molecules in the dairy base composition to gain entry into the lactic acid bacteria, and sufficiently low so that the lactic acid bacteria remains viable to carry out fermentation.

The cellular membrane of dairy fermentation strains is a comprised of fatty lipids, aligned in a manner to create a semi-permeable barrier between the dairy base and the intracellular cytosol. During the duration of the pulse, the charges increase on both sides cellular membrane increase. While not being bound by theory, it is believed that once the charges on both sides are large enough to overcome the capacitance of the membrane, the lipid molecules rapidly rearrange to form a pore for the charges to pass through, thus equilibrating the charge. Once these pores are formed, other molecules are free to utilize them to gain entry into the cytosol. Conventionally, passage of various materials into the cytosol is normally assisted by membrane spanning transporters. The rate at which the transporters operate is limited by various factors, that can include the energy that the cell has available to dedicate to this process. By creating pores through the membrane, growth supporting components or other materials are able to bypass rate limiting transporters and enter the cytosol. The pores are not permanent, thus, the growth supporting items are trapped in the cytosol at a higher than normal concentration and are available for the cellular metabolism to consume.

In an embodiment of the present invention, molecules to be introduced into the bacteria of the dairy fermentation comprise, but are not limited to, amino acids, protein fragments, free ions, organic acids, vitamins, and other nutrients beneficial to the growth of the bacterial cultures. In another embodiment of the present invention, the molecules to be introduced into the bacteria of the dairy fermentation comprise nutraceuticals beneficial to the health of humans, such as lactase enzymes that would help those who are lactose intolerant, folic acid for expectant mothers, and tri-peptides for bone health.

In a particularly preferred embodiment, the present invention enhances the symbiotic relationship of yogurt fermentation. Traditional yogurt fermentation is dependent on two strains, Lactobacillus bulgaricus and Streptococcus thermophilus. Research has found that each strain generates a nutrient that the other needs (i.e., valine and other amino acids for S. thermophilus and formic acid for L. bacillus). The use of electroporation has been found to accelerate the growth of both strains of bacteria by allowing the flow of these vital nutrients at a faster rate than normal uptake. The time saved during lag phase may be very helpful to plant production schedules as manufacturers generate more products designed using culture systems with longer fermentation times and milder conditions. It would also address the longer lag phase that occurs when using DVS (Direct Vat Set) culture systems. For example, in an embodiment of the present invention, fermentation time of the inoculated dairy base composition is at least 10% shorter, and preferably at least less than 20% shorter, than a like composition not exposed to electric pulses.

In an embodiment of the present invention, a method is provided for accelerating the fermentation of cultured dairy products with the direct application of an electric field. In some aspects, the invention involves creating pores in the cellular membrane of the dairy cultures to allow the rapid access of growth supporting items into the cellular metabolism. In a particularly preferred embodiment, the dairy fermentation cultures comprise a mixture of S. thermophilus and L. bulgaricus.

### DETAILED DESCRIPTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

Generally, the invention is directed to a process for accelerating the growth of dairy fermentation cultures with direct application of an electric field. A variety of different dairy bases may be fermented in the practice of the invention.

To facilitate the discussion of the invention, use of the invention to provide yogurt products, will be addressed. Yogurt products are selected because the advantages of the inventive concepts can be clearly presented. However, it is understood that the compositions and methods disclosed are applicable to any fermented dairy products, such as firm yogurt, drinkable yogurt, kefir, soft cream cheeses, soft cheeses including fromage frais and quark, fermented milk, yogurt-based or fermented milk desserts, smoothies, skyr, and the like. Further, the inventive compositions and methods described herein are applicable to any yogurt compositions, for example, the various styles mentioned herein, as well as the various fat levels (including low fat, nonfat, and standard yogurt). Examples of styles of yogurt include set style, stirred style, Swiss style, aerated style, and the like.

As used herein, the term “yogurt” includes, but is not limited to, all of those food products meeting the definition as set forth in the U.S. Food and Drug Administration Code of Federal Regulations (CFR) Title 21 Section 131.200, 131.203, and 131.206.

In general, a fermented dairy product such as yogurt can be made from a fermentable dairy base and bacterial culture. In addition, a fermented dairy product may include a gel-forming hydrocolloid component and, optionally, one or more additives.

Dairy bases for making a yogurt are well known and are described in, e.g., U.S. Pat. Nos. 4,971,810 (Hoyda et al.); 5,820,903 (Fleury et al.); 6,235,320 (Daravingas et al.); 6,399,122 (Vandeweghe et al.); 6,740,344 (Murphy et al.); and U.S. Pub. No. 2005/0255192 (Chaudhry et al.). In general, a dairy base includes at least one fermentable dairy ingredient. A fermentable dairy ingredient can include raw milk or a combination of whole milk, skim milk, condensed milk, dry milk (for example, dry milk solids non-fat, or MSNF). However, if desired other milks can be used as a partial or whole substitute for bovine milk, such as camel, goat, sheep or equine milk. The fermentable dairy ingredient may also comprise grade A whey, cream, and/or such other milk fraction ingredients as buttermilk, whey, lactose, lactalbumins, lactoglobulins, or whey modified by partial or complete removal of lactose and/or minerals, and/or other dairy ingredients to increase the nonfat solids content, which are blended to provide the desired fat and solids content. If desired, the dairy base can include a filled milk component, such as a milk ingredient having a portion supplied by a non-milk ingredient (for example, oil or soybean milk). Preferably, the fermentable dairy ingredient comprises bovine milk.

Preferably, the fermentable dairy ingredient is composed of bovine milk.

In general, it is well-known to typically formulate a dairy base to have a desired milk solids content and a desired fat content. In exemplary embodiments, a dairy base has a milk solids content in the range of from 1 to 50 weight percent, preferably from 4 to 25 weight percent, and even more preferably about 9 weight percent based on the total weight of the dairy base.

In addition, dairy bases of the present invention may include sweeteners, flavor ingredient(s), process viscosity modifier(s), vitamin(s), nutrient(s), combinations of these, and the like. Other ingredients that may be included are gel-forming additives, stabilizers, sequestrants, etc.

Examples of suitable sweeteners include one or more nutritive carbohydrate sweetening agents. Exemplary nutritive sweetening agents include, but are not limited to, sucrose, liquid sucrose, high fructose corn syrup, dextrose, liquid dextrose, various DE corn syrups, corn syrup solids, beet or cane sugar, invert sugar (in paste or syrup form), brown sugar, refiner's syrup, molasses, fructose, fructose syrup, maltose, maltose syrup, dried maltose syrup, malt extract, dried malt extract, malt syrup, dried malt syrup, honey, maple sugar, and mixtures thereof. In some embodiments, particularly in low fat and/or low calorie variations, the dairy base can comprise a high potency non-nutritive carbohydrate sweetening agent. Exemplary high potency sweetening agents include aspartame, sucralose, acesulfame potassium, saccharin, cyclamates, thaumatin, tagatose, rebaudioside, stevia, and mixtures thereof.

In exemplary embodiments, the sweetener is typically present in an amount of from 0 to 20 weight percent, preferably 12 to 17 weight percent based on the total weight of the dairy base composition.

In exemplary embodiments, a process viscosity modifier can be present in an amount of from 0.5 to 3 weight percent, preferably 1 to 2 weight percent based on the total weight of the dairy base composition. An exemplary process viscosity modifier can be commercially obtained from National Starch (Bridgewater, N.J.) under the tradename THERMTEX®.

Gel-forming additives suitable for use in the practice of the invention include “gel-forming hydrocolloid ingredients” which, in the context of the present invention, refer to an ingredient that disperses well in water, but due to its relatively large molecular size it is not readily soluble in water and therefore the resulting physical conformation in water is colloidal. In addition, a gel-forming hydrocolloid ingredient causes a food composition to gel to a certain degree when it is present in a given gel-forming amount and the food composition is subjected to gelling conditions. Typical gelling conditions include subjecting a dairy composition according to the present invention to a temperature in the range of from 35 to 70° F. (about 2 to about 21° C.), preferably from 35 to 55° F. (about 2 to about 13° C.), and even more preferably from 35 to 45° F. (about 2 to about 7° C.) for a time period of 0 to 12 hours. Most of the gelation will occur within 12 hours, but maximum gel set could occur after 48 hours.

In contrast to a gel-forming hydrocolloid ingredient, some hydrocolloid ingredients can be used as rheology modifiers in the processing of dairy compositions such as yogurt, but such hydrocolloid ingredients may not cause such a composition to gel when exposed to gelling conditions.

In general, gel-forming hydrocolloids are well known. A gel-forming hydrocolloid ingredient is typically a polysaccharide or protein. Preferred gel-forming ingredient(s) include non-dairy, gel-forming hydrocolloid ingredient(s).

As used herein, a non-dairy, gel-forming hydrocolloid ingredient is a gel-forming hydrocolloid ingredient that is distinguishable from a dairy, gel-forming hydrocolloid. As used herein, a dairy, gel-forming hydrocolloid ingredient refers to some materials naturally found in milk that can cause a dairy composition to gel under proper conditions. For example, milk can include casein protein and/or whey protein. Such proteins can contribute to a slight gel formation of a dairy composition when exposed to proper conditions such as pH, ion concentration, temperature, combinations of these, and the like. For example, acid produced during fermentation can cause casein protein micelle dissociation and aggregation. During heating, whey protein can be denatured, becoming insoluble and tending to cause gelation. Heat denatured whey proteins can also interact with caseins for further gelation in some dairy products. Such milk proteins can be classified as dairy gel-forming hydrocolloids.

An exemplary non-dairy, gel-forming hydrocolloid ingredient for use in the present invention can include gelatin, agar, alginate, carrageenan, pectin, starch, xanthan/locust bean gum blend, gellan gum, konjac gum, combinations of these, and the like. It is noted that some gel-forming hydrocolloid ingredients (e.g., starch) can have structural modifications that can influence the gel-forming ability of other hydrocolloids.

Examples of useful stabilizers and thickeners such as starch, gelatin, pectin, agar, carrageenan, gellan gum, xanthan gum, carboxy methyl cellulose (CMC), sodium alginate, hydroxy propyl, methyl cellulose, and mixtures thereof. In some embodiments, the dairy base can comprise a bovine, porcine, or piscine gelatin. A bovine gelatin in the range of about 200 to about 250 bloom strength can be used; also, Type B bovine gelatin in the range of about 220 to about 230 bloom strength is suitable.

When included, the stabilizers or thickeners can be included in an amount sufficient to provide a desired viscosity to the dairy base, such that the dairy base can be processed (e.g., pumped) through equipment during formulation of the inventive compositions. When measured at 20° C. (68° F.), the dairy base containing stabilizer and/or thickener has a viscosity in the range of about 1 to about 1000 centipoise (cP), preferably in the range of about 10 to about 1000 cP, based upon total weight of the dairy base.

The dairy base can also include calcium sequestrant in amounts sufficient to reduce the occurrence of premature precipitation of the protein content in the dairy base. By premature protein precipitation is meant any protein coagulation during the heating (e.g., pasteurization) or cooling steps. It is desirable that thickening of the dairy product occurs after the heat treatment such as during the fermentation step.

Exemplary soluble calcium sequestrants include, but are not limited to, sodium or potassium citrates (for example, trisodium citrate), phosphates, acetates, tartrates, malates, fumarates, adipates, ascorbates, and mixtures thereof. Good results are obtained when the sequestrant(s) is present at about 0.025% to about 0.15%.

Any bacterial culture useful in making fermented dairy products for consumption can be used with the dairy base composition. Such bacterial culture(s) are live and active and are well known. An exemplary bacterial culture can include any microorganism suitable for lactic fermentation such as Lactobacillus sp., Streptococcus sp., combinations of these, and the like. More specifically, a bacterial culture can include Lactobacillus delbrueckii subspecies bulgaricus, Streptococcus thermophilus, Streptococcus salivarius ssp thermophilus, Lactobacillus lactis, Lactobacillus casei, Lactobacillus acidophilus, Bifidobacterium lactis, Bifodobacterium bifidus, Lactococcus cremoris, Lactococcus lactis, Lactococcus lactis ss diacetylactis, combinations of these, and the like.

A variety of synonyms exist for the term “bacterial culture.” These synonyms include, for example, live culture, active culture, live and active culture, starter culture, and the like.

In a representative embodiment, the process of the invention comprises a brief application of a relatively strong electric field across a dairy base inoculated with dairy fermentation cultures. In general, the electric pulses each having a duration of from about 0.01 microsecond to about 100 milliseconds, preferably from about 1 microsecond to about 10 millisecond at a strength of from about 10 V/m to about 100,000,000 V/m, preferably at a strength of from about 1,000 V/m to about 10,000,000 V/m. In an embodiment, the dairy base is pulsed from about 3 to 12 times, and preferably from about 4 to 10 time using this relatively strong electric field.

In another embodiment, the invention comprises application of longer pulses either in square wave, sine wave, or exponential decay waveform at a relatively weaker electric field. In this embodiment, the electric field has a strength of about 0.001 V/m to about 1 V/m, preferably at about 0.01 V/m to about 0.2 V/m at a frequency of about 0.1 cycles per second to about 1000 cycles per second, preferably at about 30 cycles per second to 100 cycles per second. The duration of each pulse can be from as short as about one second in length or as long as the length of the fermentation. If pulses of short duration are employed, they can be utilized at regular or irregular intervals lasting from at least one second to 10 hours between pulses. In addition, multiple pulses and intervals can be used. A preferred embodiment is the use of five pulses of three minutes in duration, regularly spaced over an hour.

In any of the embodiments of the present invention, the application of electric field across the dairy base is provided in an amount and strength so that pores are formed for molecules in the dairy base composition to gain entry into the lactic acid bacteria.

In its preferred embodiment, several pulses are applied over the duration of the fermentation. In another embodiment, the pulses are carried out over the first half of the duration of active fermentation. In an ideal preferred embodiment, the pulses are applied immediately after inoculation. In embodiments of the present invention, the pulses are carried out within one hour, 30 minutes or within 10 minutes of inoculation. These early applications provide the prospective for the furthermost growth acceleration and because bacterial growth is generally known to be exponential, early application of an electric field provides the greatest benefits for the effort. The application of electric pulses towards the end of the fermentation has shown diminished effects, but may still be useful where one dairy fermentation culture still can utilize the stimulation. In an embodiment, the pulses are carried out until the inoculated dairy base composition reaches a pH of about 4.5.

At start up, the process employs an introduction phase. In one embodiment of the induction phase, an initial predetermined quantity of the dairy base and an initial supply of bacterial culture is added to the stirred fermentation vessel. Preferably the initial supply of dairy base is added as quickly as possible to the fermentation vessel. The dairy base and bacterial culture are then mixed until the dairy fermentation cultures have been distributed equally throughout the dairy base. The time to reach this point may vary from product to product and will depend upon such things as the formulation of the dairy base, the amount of dairy fermenting culture added, the operating weight of the fermentation vessel, the design of the agitator and or impellor, the presences of baffles or other internal structures to disrupt flow. and the degree of fermentation desired in the final product. Typical residence times may vary from 30 minutes to 2 hours. Shorter or longer initial residence times may be employed as appropriate.

In an embodiment, the process is a continuous process. In another embodiment, only a portion of the inoculated dairy base composition is treated by exposure to electric pulses at any given time. Optionally, the inoculated dairy base composition is in a fermentation vessel, and a portion thereof is pumped through an electrode configuration for exposure to the electric pulses and returned to the fermentation vessel.

In another embodiment, this application takes advantage of the known interaction between the two most prevalent dairy fermentation cultures, Lactobacillus delbrueckii subspecies bulgaricus, and Streptococcus thermophilus. It has been well documented that having both species together in a dairy base enhances the growth of both cultures together. Further experiments familiar to anyone skilled in the art have proven this relationship. Lactobacillus delbrueckii subspecies bulgaricus, is shown to stimulate the growth of Streptococcus thermophilus by releasing proteolytic enzymes that generate available amino acids, most notably but not limited to valine and histadine, in the dairy base. This relationship is reciprocated by Streptococcus thermophilus which produces simple organic molecules, most notably but not limited to formic acid and carbon dioxide, which have been shown to stimulate the growth of Lactobacillus delbrueckii subspecies bulgaricus.

It also has been proven that the uptake of these amino acids by Streptococcus thermophilus is limited by available metabolic energy. Therefore, this invention provides a method to bypass the energy limited transporters and allow these amino acids to enter directly into the cytosol.

In a preferred embodiment of the present invention, the initial inoculation of the bacterial culture is the only introduction of a bacterial culture to the fermentation vessel. Advantageously, in this embodiment the growth of dairy fermentation cultures is accelerated, thereby avoiding the need to add additional dairy fermentation cultures. Optionally, additional of dairy fermentation cultures may be added for various reasons during the fermentation process.

During the fermentation the progress is monitored in-situ. In a preferred embodiment, the measurement is carried out by use of an in-line instrument. The measurement may be continuous, periodic or intermittent. However, because the application of an electric field may disrupt the operation i.e. “fry” the in-line instrument, the user has the option to remove the inline instrument during the period of electric filed pulsing. Alternatively, off-line instruments can be used to monitor the progress of fermentation during the period of electric field pulsing.

Fermentation, both stirred and unstirred, may also be carried out by using a two stage process that employs a different fermentation temperature in each step. This is especially useful when a mixture of strains are used to comprise the dairy fermentation culture. It has been discovered that by using this multi-temperature approach, the process can be tailored to use temperatures that are best suited for each microorganism employed. This maximizes the efficiency of the fermentation process.

Typically, this approach uses a sequential approach in which the first step preferably employs the lower or lowest fermentation temperature and each successive step employs a higher fermentation temperature. Alternatively, the multi-temperature approach may comprise simultaneous fermentation of a portion of the dairy base at each different temperature followed by blending of the fermented dairy bases in a single vessel.

Depending upon the temperature, solids content, ingredients such as sweeteners, preservatives, stabilizers, etc. and amount of culture added, the induction phase can take from about 30 to 90 minutes. Preferably, the induction phase takes from 40 to 60 minutes. Final fermentation typically takes from about three to about 14 hours. In some embodiments, fermentation is performed at a temperature in the range of about 37° C. to about 49° C. (about 100° F. to about 120° F.) for about 5 hours.

The particular, target and final fermentation end points can vary modestly. Typically, the target viscosity is in the range from about 5 to 10,000 centipoise (cP) preferably from about 10 to 1,000 cP as measured at 25° C. using a Brookfield viscometer with a No. 5 spindle for 25 seconds at 10 rpm. The pH of the product in this range is typically between 6.8 and 5.0, or more specifically usually 5.9 to 5.5, respectively. The endpoint or final viscosity of the fermented dairy base typically ranges from about 5,000 to 70,000 cP, preferably from about 10,000 to 30,000 cP measured as described above. These viscosities are generally found to relate to an end point pH range from about 5.5 to about 4.3, or specifically from about 5.2 to about 4.5. The final or end point viscosity will typically be greater than the target viscosity. The final fermented dairy base so prepared can exhibit a culture count generally greater than about 1×10⁶ colony-forming units per gram (cfu/gram) to about 1×10¹⁰ cfu/gram.

The target and final viscosity values given above are only representative of useful viscosities. One of skill in the art will appreciate that the exact viscosities will vary from product to product based upon such factors as culture selection, bacteriophage, formulations, total solids content of the formulation, style, and the like.

To reduce the overall fermentation time, it is desirable to maintain a S. thermophilus concentration (measured in CFU/gm) to L. bulgaricus at a ratio of at least 10:1 in the later phase of the fermentation stage of the process, respectively. It is preferable to have S. thermophilus present at ratios of 100:1 to 10,000:1 compared to L. bulgaricus concentrations. However, depending on the duration of the fermentation, conditions of the process, slight deviations in the properties starting materials, and variation in the health and conditions of the starter culture, the bacteria strains may symbiotically strive to reach a 1:1 ratio. To enhance the effectiveness of the applied electric field, it may be necessary to: a) Introduce more S. thermophilus, directly raising their concentration; b) Add a combination of valine, leucine, histadine, glutamic acids, tryptophan, peptides containing the previous amino acids, and/or other supplements in an amount effective to enhance the growth of S. thermophilus; c) Decrease the temperature of the fermentation vessel to a level effective to enhance the growth rate of S. thermophilus and/or to decrease the growth rate of L. bulgaricus; and/or d) Reduce the concentration of soluble formate, pyruvate, purine, uracil, adenosine, guanine, adenine, peptides containing the previous amino acids, and/or carbon dioxide in an amount effective to decrease the growth rate of L. bulgaricus. e) Change the concentration of dissolved gases with redox potential, like carbon oxides, nitrogen oxides and/or molecular oxygen, with the intent to alter the metabolism of L. bulgaricus and/or S. thermophilus to achieve the desired ratio. f) Induce anaerobic or micro-aerobic conditions in the yogurt base that activate alternative metabolic networks or change growth rates of either L. bulgaricus and/or S. thermophilus to achieve the desired ratio. g) Introduce strain specific phage or other viruses that attack L. bulgaricus. h) Include modified strains of L. bulgaricus that limit growth rates or reduce stable subpopulations (either automatically or induced). i) Include modified strains of S. thermophilus that accelerate growth rates or promote higher subpopulations (either automatically or induced).

After fermentation of the dairy base to the desired end point, the fermentation process is arrested, for example, by pumping the fermented dairy base through cooling heat exchangers. At this stage, the fermented dairy base is sufficiently cooled to temperatures at which the bacterial cultures are not actively fermenting the dairy base and thus do not substantially change the viscosity. Typically, the fermented dairy product can be cooled to temperatures of about 10° C. to about 20° C. or less. In some embodiments, the fermented dairy product can be cooled to temperatures of about 4° C. or less (about 40° F. or less). The temperature at which fermentation is arrested can depend upon the particular bacterial cultures selected, and can be readily determined by one of skill in the art using standard techniques.

Thus prepared, the fermented dairy base can be characterized by a viscosity of about 5,000 to about 7,000 cP, or about 10,000 cP to about 30,000 cP (at 4.4° C.). The fermented dairy base can be further characterized as having one or more of the following additional features: a pH in the range of about 4.65 to about 4.75; a viscosity in the range of about 20,000 cP to about 30,000 cP; a solids content in the range of about 5% to about 40%, or about 10% to about 20%; a percent butterfat in the range of about 0.3% to about 6%, or about 0.5% to about 5%; and a total milk solids content in the range of about 0.01% to about 50%.

Optionally, compositions prepared by the process of the invention can further include a variety of adjuvant materials to modify the nutritional, organoleptic, flavor, color, or other properties of the composition. For example, the fermented dairy product can additionally include synthetic and/or natural flavorings, and/or coloring agents can be used in the compositions of the invention. Any flavors typically included in fermented dairy products can be used in accordance with the teachings of the invention. Also, flavor materials and particulates, such as fruit and fruit extracts, nuts, chips, and the like, can be added to the fermented dairy products as desired. The flavoring agents can be used in amounts in the range of about 0.01 to about 3%. Coloring agents can be used in amounts in the range of about 0.01 to 0.2% (all percentages based upon total weight of the fermented dairy product).

Optionally, nutrients such as vitamins can be added to the dairy base. Any vitamins typically included in fermented dairy products can be included, such as vitamin A, vitamin D, vitamin E, vitamin C, folate, thiamin, riboflavin, niacin, pyrixodine, cyanocobalamine, biotin, pantothenic acid, calcium, phosphorus, iodine, iron, magnesium, zinc, manganese, and mixtures thereof. Addition of vitamins to the style composition can minimize heat degradation of the vitamins (such as Vitamin A and Vitamin C) and minimize off-flavors that can result from loss of the vitamins during pasteurization.

When included, fruit and fruit extracts (e.g., sauces or purees) can comprise about 1% to about 40%, preferably from about 5% to 15% of the fermented dairy product. The fruit component can be admixed with the emulsifier prior to addition to the first and/or second fermented dairy bases, or can be added as a separate component, as desired.

In the manufacture of Swiss-style yogurt, a fruit flavoring can be blended substantially uniformly throughout the fermented dairy product after fermentation is complete but prior to packaging. A static mixer can be used to blend the fruit component into the fermented dairy product with minimal shear.

In the manufacture of “sundae” style yogurt, fruit flavoring can be deposited at the bottom of the container, and the container can then be filled with the fermented dairy product (e.g., yogurt mixture). To prepare a sundae style yogurt product employing a stirred style yogurt, the dairy base is prepared with added thickeners and/or stabilizers to provide upon resting, a yogurt texture that mimics a set style yogurt. In this variation, the fruit is added directly to the container, typically to the bottom, prior to filling with the yogurt.

The fruit flavoring can be provided as a sauce or puree and can be any of a variety of conventional fruit flavorings commonly used in fermented dairy products. Typical flavorings include strawberry, raspberry, blueberry, strawberry-banana, boysenberry, cherry-vanilla, peach, pineapple, lemon, orange, and apple. Generally, fruit flavorings include fruit preserves and fruit or fruit puree, with any of a combination of sweeteners, starch, stabilizer, natural and/or artificial flavors, colorings, preservatives, water, and citric acid or other suitable acid to control the pH. Minor amounts of calcium can be added to the fruit to control the desired texture of the fruit preparation typically provided by a soluble calcium material such as calcium chloride. Typical minor amounts can be less than 50 mg of calcium per 226 g serving.

If aspartame is added to the style composition, all or a portion of the aspartame can be pre-blended with the fruit flavoring.

Aeration

Optionally, the fermented dairy product can be admixed with a gas, when the desired product is an aerated yogurt product or fermented mousse. In one such embodiment, the fermented dairy product is admixed with nitrogen gas. The gas can be charged into the fermented dairy product in accordance with any conventional method. For example, the gas can be forced through small orifices into the fermented dairy product as the product flows through a tube or vessel into a mixing chamber, where uniform distribution occurs. Any conventional nontoxic, odorless, tasteless gas, such as air, nitrogen, nitrous oxide, carbon dioxide, and mixtures thereof can be used.

In accordance with some embodiments of the invention, the fermented dairy product can be aerated or whipped while maintained within a desired temperature range. Typically, the fermented dairy product will be aerated from a native density of about 1.1 g/cc to a density in the range of about 0.56 g/cc to about 0.9 g/cc, or in the range of about 0.7 g/cc to about 0.8 g/cc. The skilled artisan can select a commercially available aerator/mixer for use herein. One suitable aerator in accordance with the inventive concepts is a Tanis Rotoplus 250 aerator available from Tanis Food Tec in The Netherlands. The Tanis Rotoplus aerator consists of a mixing chamber fed by a positive displacement pump and air flow system. Product flow is controlled by pump speed adjustment and airflow is controlled by flow meter adjustment. Stainless steel concentric rows of intermeshing teeth on a stator and a rotor produce a uniformity and consistency in the mix. A coolant, for example glycol, can be used in a jacket surrounding the mix chamber to maintain a preferred constant temperature in the range of about 4° C. to about 30° C., or about 4° C. to about 15° C., or in the range of about 4° C. to about 7° C. during aeration.

A pressure in the range of about 15 psi to about 30 psi can be maintained in the mixer to aid in the formation of air cells. The aerated fermented dairy product can be gradually transported from those pressures to atmospheric pressure; the gradual shift in pressure reduces air cell collapse.

The ratio of fermented dairy product to gas can be in the range of about 3:1 to about 1:1, or in the range of about 2:1.

During aeration, it can be important to control temperature to allow large visible air cells to form more readily. Maintaining the temperature in the ranges identified above can be important to control the final density of the product which, in turn, can be important to fast formation of large visible air cells and to minimizing air cell collapse upon extended storage. It will be appreciated that desirable large visible air cells form at 24 to 48 hours with whipping and filling temperatures in the above-mentioned temperature ranges.

The aerated fermented dairy product (including any flavor components added) can then be transported to a holding tank, if desired, and held for a desired amount of time. In some embodiments, for example, it can be desirable to retain the aerated fermented dairy product in a holding tank for a time period in the range of about 5 to about 15 minutes.

The aerated fermented dairy product can then be packaged in a conventional manner for handling and storage purposes. The aerated fermented dairy product is charged to a conventional container for yogurt products, such as coated paper or plastic cups or tubes fabricated from flexible film packaging stock. After filling, the filled containers are applied with a lid or other closure or seal means, assembled into cases, and entered into refrigerated storage for distribution and sale. In some embodiments, air cells in the yogurt product can achieve visible size within about 24 to 48 hours after fill, such sizes in the range of about 130 to about 3,000 μm. About 24 to 48 hours after fill, the aerated dairy blend can achieve a viscosity of about 52,000 cP to about 55,000 cP.

In some embodiments, the fermentable dairy ingredient does not require any processing, in addition to standard homogenization and/or pasteurization, prior to use in the dairy base (for example, the inventive concepts do not require pre-processing of the fermentable dairy ingredient to remove such materials as minerals, proteins, or any other like substances).

Optionally, the method of the invention can comprise removal of water from the first dairy base to allow for addition of water in a post-fermentation addition of components such as sweetener to the fermented dairy base.

The dairy base is typically pasteurized by heating for times and temperatures effective to form a pasteurized or heat-treated dairy base. As is known, the dairy base can be heated to lower temperatures for extended times (for example, 190° F./88° C. for 30 minutes) or alternatively higher temperatures for shorter times (for example, 203° F./95° C. for about 38 seconds). Intermediate temperatures for intermediate times can also be employed, as known in the art. Other pasteurization techniques or, even sterilization, can be practiced (such as light pulse, ultra high temperature, ultra high pressure, and the like) if effective and economical.

The pasteurized dairy base is typically homogenized in a conventional homogenizer to disperse evenly the added materials and the fat component supplied by various ingredients. If desired, the pasteurized dairy base can be warmed prior to homogenization from typical milk storage temperatures of about 40° F. (about 5° C.) to temperatures of 150° F. to about 170° F. (about 65° C. to about 75° C.), preferably about 163° F. (about 73° C.). In some embodiments, homogenization is performed in a two-stage homogenizer, with a target pressure of about 1000 psi (about 6900 kPa) in the first stage, and a target pressure of about 500 psi (about 3450 kPa) in the second stage. In certain commercial practices, the sequence of the homogenization and pasteurization steps can be reversed.

The pasteurized and homogenized dairy base is then brought to incubation temperature, usually in the range of about 104° F. to about 115° F. (about 40° C. to about 46° C.). When heat pasteurization is employed, a cooling step after pasteurization can be used, wherein the homogenized and pasteurized dairy base blend is cooled to the desired incubation temperature. The cooled, pasteurized and homogenized dairy base can be characterized as having a viscosity in the range of about 5 to about 40,000 cP, preferably about 10 to about 5000 cP.

Another aspect of the invention is to utilize the living bacteria as encapsulation devices, to serve as carriers for supplements or nutraceuticals that might be degraded by agents in the fermented dairy base. Some possible mechanisms of degradation (but not limited to the following list) are: low pH, photochemical developed reactions, light derived oxidation, and available chelators. Often several factors can contribute to degrade a compound. In another aspect, it would be desirable avoid unpleasant organoleptic events that are associated with supplements or nutraceuticals. The present invention prevents such degradation and/or unpleasant organoleptic events by incorporating the supplements or nutraceuticals inside the bacteria. While not being bound by theory, it is believed that placement of these additives inside the bacteria shields the additives from adverse interactions with other ingredients or premature exposure to organoleptic receptors of the consumer.

In addition, aspects of this invention could be used to include supplements or nutraceuticals that have low or no solubility in conditions that arise within a fermented dairy base. Examples of sensitive supplements and nutraceuticals include, but are not limited to, vitamin A, carotenoids, vitamin D, phytosterol (plant sterols), vitamin E (tocopherols family), phylloquinones (including vitamin K₁), menaquinone (including vitamin K₂), ascorbic acid, thiamin, riboflavin (including vitamin B₂), panthenol, calcium pantothenate, coenzyme A, niacin, nicotinic acid, vitamin B₁₂, vitamin B₆, folates (including folic acid), coenzyme Q₁₀, synthetic oligopeptides, natural bioactive peptides, angiotensisin converting enzymes, potassium sparing diuretics, calcium sparing diuretics, osmotic based diuretics, loop diuretics, general antihypertensives, xanthenes, thiazides, casokinins, lactokinins, ferrous sulfate, Mohr's salts, conjugated linoleic acids, docosahexaenoic acid, omega-3 fatty acids, omega-6 fatty acids, linoleic acids, polyunsaturated fatty acids, Calcium salts, aspartame, sucralose, saccharin, acesulfame potassium, alitame, neotame, brazzein, curclin, erythritol, glycerol, isomalt, inulin, mannitol, miraculin, monellin, sorbitol, stevia, tagatose, thaumatin, xylitol, and mixtures thereof.

Aspects of the inventive concepts will now be described with reference to the following non-limiting examples.

### Example #1

A typical yogurt base comprising water, non-fat dried milk, crystalline sugar, cream, starch, and gelatin were blended according the weight percentages in the table.

TABLE 1
Formula for Typical Yogurt Base in Example #1

| Ingredients | % (w/w) |
|---|---|
| Water | 70% |
| Non-Fat Dried Milk | 10% |
| Dry Sugar | 8% |
| Cream | 5% |
| Starch | 4% |
| Gelatin | 3% |
| Total | 100% |

### Homogenization and Pasteurization

The mixture was homogenized in two stages at 500 psi then 400 psi. Next, the yogurt base was pasteurized at 93.3 C for 20 seconds at a rate of 17.8 lbs per minute. If desired, an additional step of holding the dairy base at 85 C for 25 minutes can be included to degrade milk proteins. After the pasteurization, the yogurt base was cooled to 110° F. and 2 L transferred into a glass fermentation vessel (Omniculture Benchtop Fermentor, The VirTis Company, Gardiner, N.Y., USA).

### Fermentation Conditions

The fermentation vessel was maintained at 110° F. via a jacketed water bath. To start the fermentation, 0.02 percent by weight of a freeze dried yogurt starter culture containing Streptococcus thermophilus, and Lactobacillus bulgaricus at a ratio of 1:1 was added to the vessel (Danisco A/S, Copenhagen, Denmark). The yogurt base was agitated for five minutes with the internal impellor to distribute the freeze dried culture at 120 rpm. The pH was measured offline with a Metrohm 691 pH meter and a PT1001B12 probe (Metrohm, Herisau, Switzerland). The initial pH of the yogurt base was 6.5.

### Electropermeabilization Variation 1

The fermentation vessel was fitted with two electrodes which extend from the head plate of the fermentor into the inoculated dairy base. The leads from the electrode are connected to an Agilent pulse generator 8111A (Agilent Technologies, Santa Clara, Calif., USA). Five pulses of approximately 10 ms were applied to the fermenting dairy base with field strength of 200,000 V/m at 60 cycles per second. The time length in between pulses was one minute. A spare vessel without electrodes, but containing dairy base from the same batch and starter culture from the same lot was used as a control.

### Tracking and Conclusion of Fermentation

The progress of fermentation was tracked using off-line pH measurements taken at regular 15 minute intervals from the pH probe. It was found over repetition of experiments at these conditions that the electropermeabilized cultures reached the target pH of 4.5 approximately 15-20% faster than the control. At the conclusion of the fermentation, samples were removed from the fermentation vessel and chilled rapidly to 40° F. Cell counts were taken and compared between the finished products. The electropermeabilization treatment resulted in slightly higher cell counts for the Streptococcus thermophilus strain when compared to the control. The Lactobacillus bulgaricus counts were not considerably different than the control strain.

### Electropermeabilization Variation 2

The same equipment was used as in variation 1. Pulses 1 minute were applied to the fermenting dairy base with field strength of 200,000 V/m at 60 cycles per second. The length in between pulses was fifteen minutes. This process was continued for the duration of the fermentation. A spare vessel without electrodes, but containing dairy base from the same batch and starter culture from the same lot was used as a control.

### Tracking and Conclusion of Fermentation

The progress of fermentation was tracked using off-line pH measurements taken at regular 15 minute intervals from the pH probe. It was found over repetition of experiments at these conditions that the electropermeabilized cultures reached the target pH of 4.5 approximately 15% faster than the control. At the conclusion of the fermentation, samples were removed from the fermentation vessel and chilled rapidly to 40° F. Cell counts were taken and compared between the finished products. The electropermeabilization treatment resulted in slightly higher cell counts for the Streptococcus thermophilus strain when compared to the control. The Lactobacillus bulgaricus counts were not considerably different than the control strain.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A process for preparing a dairy fermentation product comprising:
a) providing a dairy base composition;
b) inoculating lactic acid bacteria into the dairy base composition and initiating fermentation;
c) providing electrodes in direct contact to the inoculated dairy base composition;
d) creating at least one electric pulse using the electrodes at an electric field strength sufficiently high to form pores in the lactic acid bacteria to allow molecules in the dairy base composition to gain entry into the lactic acid bacteria, and sufficiently low so that the lactic acid bacteria remains viable to carry out fermentation.

2. The process of claim 1, wherein the electric pulses each have a duration of from about 0.01 microsecond to about 100 milliseconds, at a strength of from about 10 V/m to about 100,000,000 V/m, and the inoculated dairy base is pulsed from about 3 to about 12 times.

3. The process of claim 1, wherein the electric pulses each have a duration of from about 1 microsecond to about 10 milliseconds, at a strength of from about 1,000 V/m to about 10,000,000 V/m, and the inoculated dairy base is pulsed from about 4 to about 10 times.

4. The process of claim 1, wherein the electric pulses each have a strength of about 0.001 V/m to about 1 V/m, and at a frequency of about 0.1 cycles per second to about 1000 cycles per second.

5. The process of claim 1, wherein the electric pulses each have a strength of about 0.01 V/m to about 0.2 V/m, and at a frequency of about 30 cycles per second to 100 cycles per second.

6. The process of claim 1, wherein the lactic acid bacteria is a mixture of Lactobacillus sp., Streptococcus sp. and combinations thereof.

7. The process of claim 1, wherein the lactic acid bacteria is selected from the group consisting of Lactobacillus delbrueckii subspecies bulgaricus, Streptococcus thermophilus, Streptococcus salivarius ssp thermophilus, Lactobacillus lactis, Lactobacillus casei, Lactobacillus acidophilus, Bifidobacterium lactis, Bifodobacterium bifidus, Lactococcus cremoris, Lactococcus lactis, Lactococcus lactis ss diacetylactis, and combinations thereof.

8. The process of claim 1, wherein the lactic acid bacteria is a mixture of Lactobacillus delbrueckii subspecies bulgaricus, and Streptococcus thermophilus.

9. The process of claim 8, wherein the S. thermophilus concentration to L. bulgaricus ratio at the completion of the fermentation process is at least 10:1.

10. The process of claim 8, wherein the S. thermophilus concentration to L. bulgaricus ratio at the completion of the fermentation process is at from about 100:1 to about 10,000:1.

11. The process of claim 1, wherein the initial inoculation of the bacterial culture is the only introduction of lactic acid bacteria into the dairy base composition.

12. The process of claim 1, wherein the pulses are carried out over the duration of active fermentation.

13. The process of claim 1, wherein the pulses are carried out over the first half of the duration of active fermentation.

14. The process of claim 1, wherein the pulses are carried out within 30 minutes of inoculation.

15. The process of claim 1, wherein the pulses are carried out within 10 minutes of inoculation.

16. The process of claim 1, wherein the pulses are carried out for a time period of about 1 to about 15 minutes.

17. The process of claim 1, wherein the pulses are carried out until the inoculated dairy base composition reaches a pH of about 4.5.

18. The process of claim 1, wherein the process is a continuous process.

19. The process of claim 1, wherein only a portion of the inoculated dairy base composition is treated by exposure to electric pulses at any given time.

20. The process of claim 19, wherein the inoculated dairy base composition is in a. fermentation vessel, and a portion thereof is pumped through an electrode configuration for exposure to the electric pulses and returned to the fermentation vessel.

21. The process of claim 1, wherein the dairy fermentation product is yogurt.

22. The process of claim 1, wherein the molecules that gain entry into the lactic acid bacteria are nutrients.

23. The process of claim 22, wherein fermentation time of the inoculated dairy base composition is at least 10% shorter than a like composition not exposed to electric pulses.

24. The process of claim 1, wherein the molecules that gain entry into the lactic acid bacteria are nutraceuticals.
